(19) United States
(12) Patent Application Publication
(10) Pub. No.: US 2001/0041998 A1
(43) Pub. Date: Nov. 15, 2001

(54) Land port system and method for fuel cell vehicles

(75) Inventors: Geoffrey E.H. Ballard, West Vancouver (CA); Michael Routtenberg, Surrey (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: General Hydrogen Corporation, a Delaware Corporation

(21) Appl. No.: 09/773,271

(22) Filed: Jan. 29, 2001

Related U.S. Application Data
(60) Provisional application No. 60/178,690, filed on Jan. 28, 2000.

(51) Int. Cl. G06F 17/60

(52) U.S. Cl. 705/8

(57) ABSTRACT

The present invention provides a method and system for operating an urban infrastructure of land ports. This infrastructure includes Truck Terminals that physically provide the land port service; a Central Scheduling Agency that transacts and dispatches pick ups and deliveries; a Land Port Credit Exchange that trades land port delivery credits between heavy duty diesel truck tractor (HDDT) owners; and a Government Fee Collection Agency. Land ports are adapted truck terminals located near transportation arteries at the perimeters of urban areas, that have been suitably configured to exchange trailer loads between HDDTs and zero emission hydrogen fuel cell vehicles (ZEVs). The ZEVs ferry trailer loads between land ports and the inner city, thereby causing a reduction in the vehicle miles traveled by HDDTs within dense urban areas. This reduces the inner city emissions of toxic diesel exhaust, mitigating damage both to the environment and to human health.

### CROSS REFERENCE TO RELATED APPLICATIONS

This application claims the benefit of U.S. Provisional Application No. 60/178,690, filed Jan. 28, 2000.

### FIELD OF THE INVENTION

This invention generally relates to a business model and, more specifically, to a method and system for operating an urban infrastructure of land ports.

### BACKGROUND OF THE INVENTION

a. The Need to Mitigate Inner City Diesel Pollution

Diesel engines emit, to varying degrees, a highly toxic cocktail of gasses, compounds and particulate matter. These include, carbon monoxide, oxides of nitrogen, sulfur dioxides, aromatic polycyclic hydrocarbons and diesel particulate matter (PM).

Carbon monoxide is readily absorbed by the blood and reduces oxygen transport. Long term exposure can cause heart disease, memory impairment and adverse reproductive effects. Oxides of nitrogen such as nitrogen dioxide and nitric oxide cause smog and acid rain. Exposure to nitrogen dioxide can cause pneumonia and lung damage. Prolonged exposure may cause severe breathing difficulties. Sulfur dioxide turns into sulfuric acid when it contacts atmospheric moisture, thereby causing lung damage and forming acid rain.

Aromatic polycyclic hydrocarbons (PAHs) are complex organic substances including compounds known to be cancer causing agents. These compounds are absorbed by the diesel particulate matter (PM), which in turn lodges in the lungs. Diesel PM is comprised of tiny particles ranging in size from less than 2.5 microns (PM2.5) to 10 microns (PM10). These particles, when clumped together, create what is commonly referred to as diesel soot. Diesel PM, highly absorbent of chemicals and gasses, forms a suspension within the air and is invisible to the unaided human eye. Diesel PM2.5 is the most lethal of all diesel particulate matter because it becomes permanently lodged in the lungs and carries carcinogenic compounds such as PAH.

Diesel trucks, while making up about two percent of the on-road vehicle fleet, contribute about 30% of the oxides of nitrogen and 65% of the PM.

In California, the California Air Resources Board (“CARB”) has classified diesel PM as a toxic air contaminant and the South Coast Air Quality Management District (“SCAQMD”) has published a study showing that 72% of the risk from cancer air contaminants is attributable to diesel PM. Other health risks from PM2.5 include pneumonia, asthma and other respiratory diseases, and greater risk of death from cardiopulmonary causes. The lifetime risk of premature death from exposure to diesel PM concentrations in California is about 4,250 cases per million, or one person in 235.

Statistics and reports such as the above are placing substantial pressure on regulators and industry to “clean up’ the diesel emissions. In an almost parallel path to the tobacco industry, the trucking industry, after decades of pollution effect on billions of people, is now facing the potential of crippling class action suits in North America. At the turn of the 21^{st} century, trucking industry publications began warning their members of such legal threats, which could immediately thrust the industry into the mainstream political spotlight. In January 2000, for the first time, a California city indicated its intention to crack down on diesel emissions. The Trucking Association hopes to find a way to quell the movement before it spreads into a national war over the health effects of truck exhaust.

b. Conventional Schemes for Reducing Diesel Emissions

Major oil and automobile companies, which have large investments in diesel fuel related plants and infrastructures, cannot economically justify abandoning the production of diesel fuels and vehicles. However, in recognition of the growing concern over diesel emissions, the oil and automobile industries are working together to introduce “clean diesel”, which is implemented through both reformulated fuels and redesigned diesel engines. Shell Oil, for example, has developed PURA fuels that reduce sulfur content by 90%. Low sulfur fuels coupled with advanced emission control technologies such as soot traps, filters and electronic engine monitoring strive to reduce certain harmful diesel emissions by up to 75%.

The clean diesel solution, however, even if technically and economically feasible, remains a short-term remedy, because it will eventually be offset by the exponential growth in the size of diesel truck fleets. Further, clean diesel does nothing about carbon dioxide emissions, which have been implicated in global warming.

### SUMMARY OF THE INVENTION

The present invention provides a system and method for reducing the emissions of toxic diesel exhaust in inner cities, thereby mitigating damage both to the environment and human health. The system and method includes the creation of an urban infrastructure of hydrogen land ports, a purpose of which is to reduce the inner city vehicle miles traveled by heavy duty diesel truck tractors (HDDTs). The land port infrastructure described in this invention utilizes truck terminals that are located near transportation arteries at the perimeter of urban areas, and employs such truck terminals to function as entry barriers to certain HDDTs originating from outside the urban area. The land ports serve as entry barriers by virtue of enabling such HDDTs to exchange their trailer loads with zero emission vehicles (ZEVs), which haul the trailers into and out of the inner city. The HDDT trucks, in turn, return to the outbound interstate directly, without ever entering the inner city. Such truck terminals, which may be either new or existing, are suitably configured to function within the land port infrastructure.

Suitable configuration includes the ability of aforementioned truck terminals to: accommodate and refuel ZEVs; exchange trailer loads between HDDT tractors arriving at the land port and the ZEVs that ferry trailer loads between land ports and the inner city; and to coordinate with various administrative agencies which may include some or all of: a central scheduling agency that dispatches pick ups and deliveries between the land ports and the inner city; a Government Fee Collection Agency that collects land port user fees from, and issues land port user credits to owners of HDDT tractors; and a Land Port Credit Exchange that allows land port delivery credits to be traded between HDDT owners.

The present invention is described in terms of inner cities and other urban areas, but is to be understood to also have utility with other areas in which it is beneficial to reduce emissions, such as environmentally sensitive parks or reserves.

While the present invention has primary utility when used with diesel powered vehicles, it may also be utilized with networks of other fossil fuel powered vehicles, such as gasoline powered vehicles.

The present invention is preferably implemented with hydrogen fuel cell vehicles operating in the urban areas. However, the use of other zero emission vehicles, such as electrical energy battery powered vehicles, are also within the scope of the present invention.

The invention describes a novel system and method for employing HDDT owners; Truck Terminals; a Central Scheduling Agency; a Government Fee Collection Agency; and a Land Port Credit Exchange as multiple constituent elements in the creation and management of a land port infrastructure.

Certain of the above constituent elements, specifically the Central Scheduling Agency and the Land Port Credit Exchange, are created as part of this invention.

Additionally, the invention provides a system and method for all of the above constituent elements to operate individually and with respect to one another, including a system and method for exchanging mutual transactional data.

The invention employs wide area data networks, including the Internet and/or telephone networks to link the constituent elements together and, in the preferred embodiment, to provide a high degree of automation in connection with operating the land port infrastructure.

The function of each of the constituent elements as used herein, are as follows:

HDDT Owners

HDDT owners are the HDD truck tractor owners that have an existing requirement to pay an annual or periodic registration fee to Government Fee Collection Agencies (“GFCAs”) in the jurisdiction in which they operate. This invention provides that a portion of such fees are used to support the land port infrastructure. As one suitable embodiment of the invention in exchange for fees paid, the GFCAs deposit credits into the HDDT owners' accounts maintained at the Land Port Credit Exchange (LPCEx).

Truck Terminals

Truck terminals are utilized by the trucking industry to consolidate or reconfigure loads. Typically trailer loads are transferred between HDDTs to maximize load and/or scheduling efficiency. Truck terminals adapted for use as land ports maintain a fleet of ZEV truck tractors and/or trucks that are utilized to render inner city pick up and delivery service for inbound HDDT trucks. HDDTs pay for such service with land port delivery credits from their LPCEx account.

Central Scheduling Agency (CSA)

The CSA is an organization that is created in accordance with the terms of this invention. The CSA receives requests from trucking companies and/or drivers to pick up outbound inner city trailer loads and deliver them to designated land ports. Alternatively it receives requests from trucking companies and/or drivers to deliver, to the inner city, trailer loads hauled to land ports by inbound HDDTs. The CSA schedules and dispatches the collective fleet of land port affiliated ZEVs and optimizes inner city pick up and delivery scheduling. Pick up and delivery requests are received by the CSA by suitable electronic networks, including wide area data networks, such as the Internet and/or telephone networks.

The CSA shares data with the GFCAs and the LPCEx. Before confirming a pick up or delivery order, it confirms that the party issuing the order has sufficient credits in its LPCEx account and deducts the appropriate credits for the service requested. Upon receiving confirmation that the land port delivery service has been rendered, the CSA transmits transactional data to the LPCEx, which in turn settles accounts between all parties involved in the delivery transaction.

Government Fee Collection Agencies (GFCAs)

The GFCAs are typically the same agencies that already collect any applicable annual federal, state, county or municipal HDDT road license fees. Land port user fees are collected, suitably by adding such fees to the annual dues, and maintained in a separate reserve account. For each fully paid up HDDT account, the GFCA deposits land port delivery credits into the truck's account with the LPCEx. In the preferred embodiment, all HDDT trucks in a given weight class are charged the same annual premium and receive the same number of annual credits. The GFCAs utilize the proceeds in the reserve account to pay the LPCEx, which in turns settles accounts with all parties for scheduling, dispatch and tracking services rendered, and the truck terminals for land port services rendered.

Land Port Credit Exchange (LPCEx)

The LPCEx is an entity that is created in accordance with the terms of this invention. It serves three important functions. First, it allows free market forces to place the initially equally distributed land port credits in the hands of parties that can best utilize them. Second it allows parties who do not require land port services to sell their credits, for cash, to parties desiring more extensive use of land ports than their pre-allotted number of credits would otherwise allow. Third, it functions as a central financial clearing house for all parties to the land port delivery transaction. These functions are best explained with an example.

Assume a land port infrastructure is established in a jurisdiction that has 1,000,000 registered HDDTs that are required to purchase annual land port usage credits. Assume also that the ZEV truck fleet used for land port deliveries includes 4,000 vehicles each capable of making 600 pick-ups and deliveries annually, yielding an aggregate of 2,400,000 annual trips. Further assume that each trip costs exactly one land port credit. The net result is that each HDDT is awarded 2.4 delivery trips annually. Since HDDTs have different delivery routes, the fixed number of land port credits awarded to each HDDT is unlikely to match its specific requirements. Furthermore, since one delivery trip requires one land port credit, it must be made possible to purchase additional fractional units, to unitize delivery credit account balances. The LPCEx meets both of these requirements by allowing parties to buy and sell credits to meet their individual needs. Finally, it allows each of the parties to the transaction to deal with a single entity, thus reducing the administrative burden for all parties.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a pictorial representation of the Land Port Concept.

FIG. 2 is a schematic representation of Land Port Infrastructure and Business Process.

### DETAILED DESCRIPTION OF THE PREFERRED EMBODIMENT

a. Land Port Concept

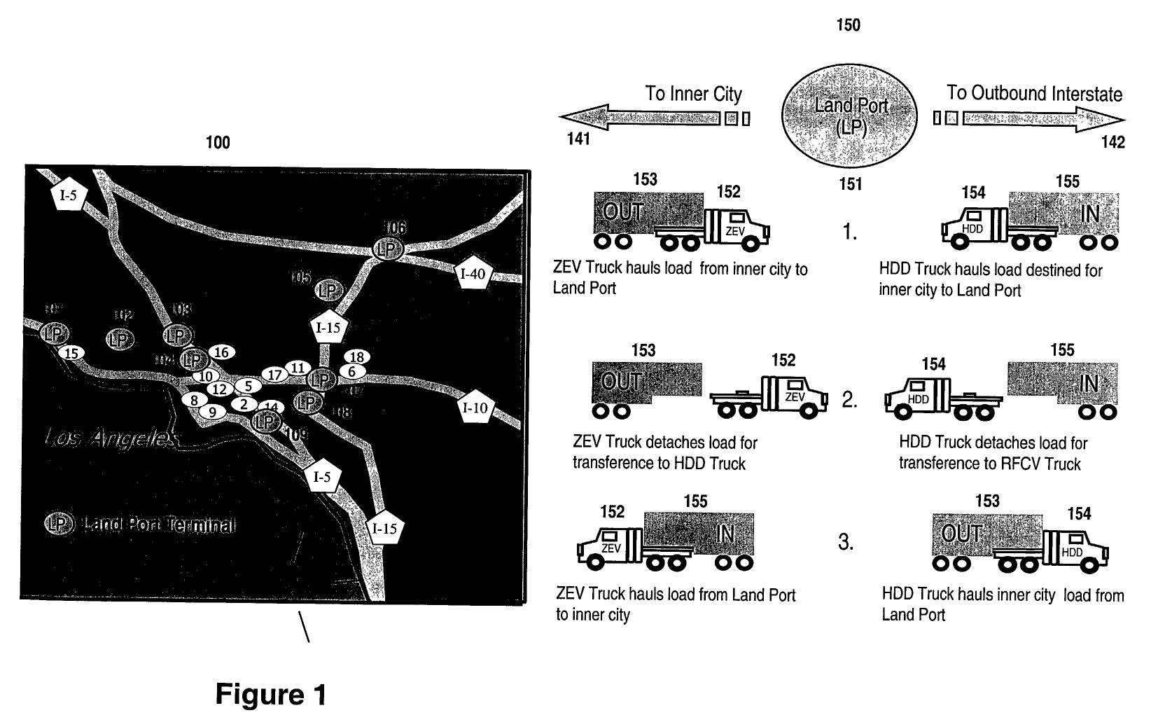

FIG. 1 depicts an example of some of the elements of one embodiment of the land port infrastructure. For convenience, Southern California is used as the example, without limitation. With the exception of the specific geography, arterial routes and truck terminals shown in the figure, the land port infrastructures depicted in the diagram are identically applicable to other urban areas.

The map on the left (100) depicts existing truck terminal locations (1 through 22) in the region. Certain of these terminals (101 through 109) have been adapted to function as land ports, in accordance with the disclosures contained within this patent application. The land ports (101 through 109) are distributed about the perimeter of the inner city or other area to be served with ZEVs, to create an infrastructure that functions as a selectively permeable barrier. The barrier has the ability to stop heavy duty diesel tractor trucks (HDDTs) from entering the inner city, while allowing the free movement of goods contained within trailer loads hauled by the HDDTs.

The schematic on the right (150) represents the flow of vehicular traffic into and out of a single representational land port (151).

In row one of the schematic, the ZEV (152) hauls a load (153) from the inner city to the land port (151). Conversely, the HDDT (154) hauls a load (155), destined for the inner city, to the land port (151).

In row two of the schematic, the ZEV (152) unhitches its load for transference to the HDDT (154). Likewise the HDDT (154) unhitches its load for transference to the ZEV (152). The loads (153 & 155) are suitably re-hitched and thus exchanged between the ZEV (152) and the HDDT (154).

In row three of the schematic, the ZEV (152) ferries the inbound load to the inner city for delivery at its final destination. Likewise, the HDDT (154) transports the outbound load to its ultimate delivery point.

The net result of the land port infrastructure is that inner city HDDT vehicle miles are replaced with ZEV vehicle miles, with a resulting reduction in atmospheric diesel emissions.

b. Hydrogen Land Infrastructure and Business Process

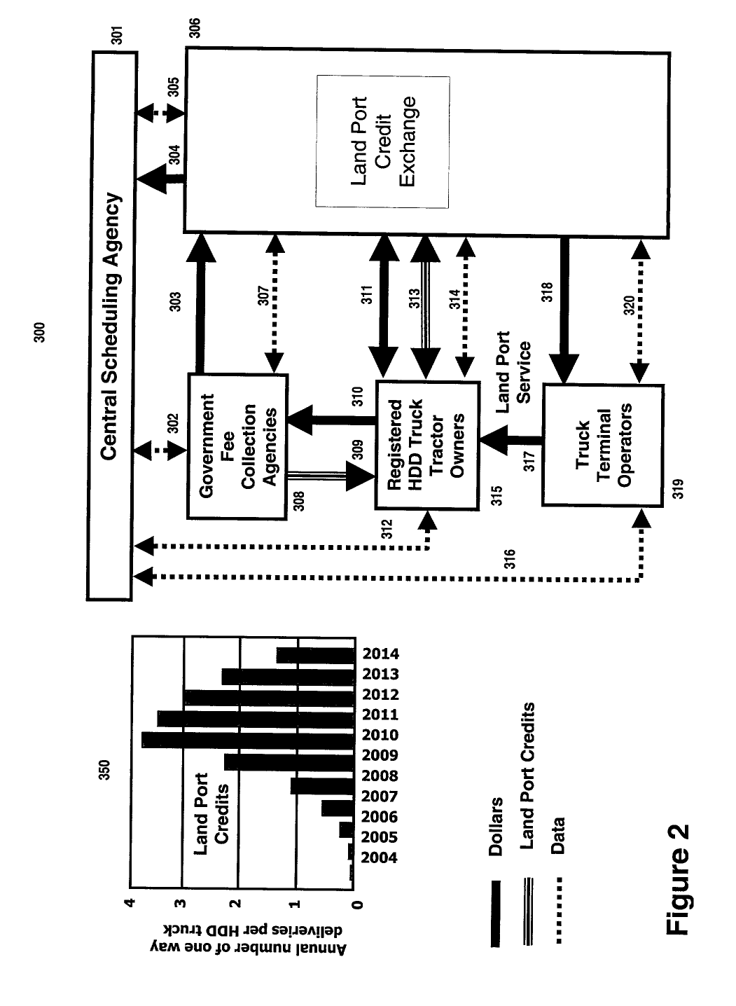

FIG. 2 provides a schematic representation of aspects of the ZEV land port infrastructure and the associated business process, disclosed in this patent application. An aspect of the invention is that it places little additional administrative burden on government agencies. Such administrative activities are carried out by the two private enterprise institutions suitably created and operating in accordance with the methods disclosed in this invention. These institutions are: the Central Scheduling Agency (CSA) and the Land Port Credit Exchange (LPCEx), whose functions have been described herein. The LPCEx functions as the central clearing house for all transactions between the plurality of parties involved in the land port infrastructure. This streamlines dealings for each of the parties, who need to deal with only one entity to handle all financial transactions associated with usage and operation of the land port infrastructure. While described as separate agencies, the CSA and LPCEx could be combined into a single agency serving dual functions.

HDDT owners (315) pay an annual land port user fee (310) to Government Fee Collection Agencies (GFCAs) (308), or alternately a privatized organizations operating under government contract. In exchange for user fees paid, the GFCAs (308) provides each HDDT owner with an applicable fixed number of land port credits (309) that are deposited in the HDDT owner's account, maintained at the Land Port Credit Exchange (LPCEx) (306). In the preferred embodiment such deposit is executed automatically and electronically via a wide-area data network (307), contemporaneously with the HDDT owner's (315) fee payment (310).

For illustrative simplicity, this schematic assumes an exchange rate equal to one land port credit for one delivery between the land port and the inner city. However, an aspect of the invention includes the ability to establish an arbitrary exchange rate between credits and deliveries, or alternatively, different exchange rates for various different types of delivery service provided. By employing an exchange rate of unity, the graph (350) provides an example of the annual number of land port credits that might be awarded each HDDT owner. In this example, the credits range from a low of approximately 0.05, in 2004 to a high of approximately 3.8, in 2010. Further, the credits awarded always have a fractional component.

The LPCEx (306) allows HDDT owners (315) to trade credits between themselves (and, potentially, outside parties as well) so that each HDDT owner (315) may achieve a credit account balance consistent with its land port delivery requirements. An aspect of the LPCEx (306) is that it allows trading parties to top up their account with as many additional credits, fractional or otherwise, as necessary to fully redeem account credits for land port services or receive a cash settlement or other monetary consideration for pre-allotted or unused credits, fractional or otherwise. Net purchases and sales of land port credits (313) by HDDT owners (315) are ultimately settled, either individually or in the aggregate, via cash transactions (311) between HDDT owners (315) and the LPCEx (306). In the preferred embodiment credit trades between HDDT owners (315), are transacted between the respective HDDT owners (315) and the LPCEx (306), via electronic networks (314), including a wide area data network, such as the Internet, or a telephone network employing live brokers.

HDDT owners (315) redeem land port credits for land port delivery service via the Central Scheduling Agency (CSA) (301). Via electronic networks (312), including a wide area data network, such as the Internet, or a telephone network employing live operators, HDDT owners (315) request delivery services from the CSA (301). Such requests include specific pick up and delivery instructions, including times and locations, and the nature of the delivery service required. Such delivery services may include an: inbound delivery, where a load is delivered from the land port to the inner city; an outbound delivery, where a load is delivered from the inner city to the land port; or a coordinated delivery. In a coordinated delivery, the land port delivers the outbound load to the land port in advance of the HDDT arriving with its inbound load. The coordinated delivery allows the HDDT to swap inbound and outbound loads forthwith, to maximize the HDDT driver's productive driving time.

Via an electronic data network (305), the CSA (301) verifies that the HDDT owner (315) has sufficient credits in its LPCEx (306) account for the requested service. Then, via the same data network (305) the CSA (301) utilizes the LPCEx (306) to deduct the appropriate credits from the account of the HDDT owner and authorizes cash or other monetary consideration or credits to the accounts of parties participatory to the delivery service. Such parties may include the Truck Terminal Operators (319), scheduled to provide the land port delivery service; the CSA (301), for providing the scheduling service, and the LPCEx (306), for providing brokerage services. The CSA (301) schedules the pick-ups and deliveries via, in the preferred embodiment, fleet scheduling software, and provides the Truck Terminal Operators (319) with vehicle dispatch notification via the wide-area data link (316).

At the scheduled time, the Truck Terminal Operator(s) (319) provide(s) the required land port delivery service (317) to the HDDT owner (315). The HDDT owner (315) and the Truck Terminal Operator(s) (319) notify the CSA (301) via the wide area data links (312 & 316 respectively) to confirm that land port delivery service (317) has been completed. In turn, the CSA (301), via the data link (305), notifies the LPCEx and authorizes cash or other monetary consideration or credits to the accounts of parties participatory to the delivery service. The corresponding cash debit is applied to the account(s) of the GFCAs (308) that is maintained at the LPCEx (306).

The LPCEx (306) reports all details of the delivery transaction to the Truck Terminal Operator(s) (319) via the data link (320). The CSA (301) provides all details of the delivery transaction, which may include a full audit trail, to the GFCA (308) via the data link (302). Periodically, or upon request, the LPCEx (306) issues payments (304, 311 & 318), in the form of checks, electronic transfers, or otherwise, to LPCEx account holders (with the exception of the GFCA) that have positive cash credit balances. Periodically, or upon request from the LPCEx (306), the GFCA (308) issues payments, in the form of checks, electronic transfers, or otherwise, to the LPCEx (306) for deposit into the GFCA's LPCEx account.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A method for transferring freight comprising:
providing a network of a plurality of ports disposed near corresponding urban areas;
causing a plurality of zero emission vehicles (ZEVs) to carry freight to and/or from a port and a corresponding urban area;
inducing through economic incentives a plurality of fossil fuel burning vehicles to utilize services of the ports to carry freight both to and from urban areas, utilizing the ZEVs associated with the ports; and
coordinating the transfer of freight between the plurality of ZEVs and the plurality of fossil fuel burning vehicles at the plurality of ports.

2. The method of claim 1 further comprising the step of:
scheduling and dispatching the plurality of ZEVs relative to arrival at and departure from the plurality of ports at which freight is transferred between the plurality of ZEVs and the plurality of fossil fuel burning vehicles.

3. The method of claim 1 further comprising the step of:
collecting fees from owners/operators of the plurality of fossil fuel burning vehicles by utilizing new or existing government fee collection agencies, or agents thereof, to fund the plurality of ports through a system of land port usage credits, which are credited to a land port credit exchange account of the owners/operators, upon payment of the fees.

4. The method of claim 3 further comprising the step of:
providing a commodities exchange for the owner/operators of the plurality of fossil fuel burning vehicles to trade land port usage credits between and among themselves, such that a first subset of owner/operators have credits debited from their accounts in exchange for payments issued by the Exchange, and a second subset of owner/operators have credits credited to their accounts in exchange for payments paid to the exchange by the second subset of owner/operators.

5. The method of claim 4 further comprising the step of:
establishing, via the exchange, the fair market value of the credits, as determined by the market forces of supply and demand.

6. The method of claim 1 further comprising the step of:
providing the means for owner/operators to redeem their respective exchange credits for delivery services provided to them by the plurality of ports.

7. The method of claim 1 further comprising the step of:
providing the means to transfer payment to land port operators from GFCAs, upon delivery of land port services to such owner/operators.

8. A method for transferring freight comprising:
providing a network of a plurality of ports disposed near corresponding urban areas;
inducing a plurality of zero emission vehicles to carry freight to and/or from a port and a corresponding urban area;
inducing a plurality of fossil fuel burning vehicles to carry freight in areas outlying the urban area to and from a corresponding port; and
coordinating the transfer of freight between the plurality of zero emission vehicles and the plurality of fossil fuel burning vehicles at the plurality of ports.

9. The method of claim 8 further comprising the step of:
scheduling and dispatching the plurality of zero emission vehicles relative to arrival at and departure from the plurality of ports at which freight is transferred between the plurality of zero emission vehicles and the plurality of fossil fuel burning vehicles.

10. The method of claim 8 further comprising the step of:
debiting and crediting accounts of owners/operators of the plurality of zero emission and fossil fuel burning vehicles as their vehicles deliver freight to and pick up freight from the plurality of ports.

11. The method of claim 10 further comprising the step of:
collecting fees from owners/operators of the plurality of fossil fuel burning vehicles to fund the plurality of ports.

12. The method of claim 8, wherein the plurality of zero emission vehicles are hydrogen fuel cell powered trucks.

13. The method of claim 8, wherein the freight is contained and transferred in trailers between fossil fuel powered truck tractors and zero emission truck tractors.

14. A method for transferring freight from an outlying area to an urban area comprising the steps of:
providing a port by utilizing existing or new truck terminals;
inducing a fossil fuel burning vehicle carrying freight destined for an urban area to stop at the port;
transferring the freight from the fossil fuel burning vehicle to a zero emission vehicle; and
carrying the freight on the zero emission vehicle into the urban area.

15. A method for transferring freight from an urban area to an outlying area comprising the steps of:
providing a port by utilizing existing or new truck terminals;
inducing a zero emission vehicle carrying freight destined for an outlying area to stop at the port;
transferring the freight from the zero emission vehicle to a fossil fuel burning vehicle; and
carrying the freight on the fossil fuel burning vehicle into the outlying area.

16. A method for exchanging freight between an urban area and an outlying area comprising the steps of:
providing a port by utilizing existing or new truck terminals;
inducing a fossil fuel burning vehicle carrying a first freight destined for an urban area to stop at the port;
inducing a zero emission vehicle carrying a second freight destined for an outlying area to stop at the port;
transferring the first freight from the fossil fuel burning vehicle to the zero emission vehicle;
transferring the second freight from the zero emission vehicle to the fossil fuel burning vehicle;
carrying the first freight on the zero emission vehicle into the urban area; and
carrying the second freight on the fossil fuel burning vehicle into the outlying area.

17. The method of claim 16 further comprising the step of:
scheduling and dispatching the zero emission vehicle relative to arrival at and departure from the port at which freight is transferred between the zero emission vehicle and the fossil fuel burning vehicle.

18. The method of claim 16 further comprising the step of:
debiting and crediting accounts of owners/operators of the zero emission and fossil fuel burning vehicles as their vehicles deliver freight to and pick up freight from the port.

19. The method of claim 18 further comprising the step of:
collecting fees from owners/operators of fossil fuel burning vehicles to fund the port.

20. The method of claim 16 wherein the port is disposed proximate the perimeter of the urban area.

21. The method of claim 16 wherein the first freight and the second freight are contained and transferred in trailers between a fossil fuel burning truck tractor and a zero emission truck tractor.

22. The method of claim 16 wherein the zero emission vehicle is a hydrogen fuel cell powered truck.

23. The method of claim 16, further comprising:
inducing a plurality of fossil fuel powered vehicles and a plurality of zero emission vehicles to stop at the port for transfer of freight therebetween.

24. The method of claim 23, further comprising:
providing a plurality of networked ports, each adjacent a corresponding urban area, between which the fossil fuel burning vehicles carry freight.

25. A system for transferring freight between a plurality of fossil fuel burning vehicles and a plurality of zero emission vehicles comprising:
a plurality of ports disposed near corresponding urban areas;
a plurality of zero emission vehicles associated with each port and carrying freight to and from an associated port and a corresponding urban area;
a plurality of fossil fuel burning vehicles carrying freight in areas outlying the urban areas to and from the plurality of ports; and
a controller networked to the plurality of ports to coordinate the transfer of freight between the plurality of zero emission vehicles and the plurality of fossil fuel burning vehicles at the plurality of ports.

26. The system of claim 25 further comprising:
a scheduling agency in communication with the controller for scheduling and dispatching the plurality of zero emission vehicles and/or the plurality of fossil fuel burning vehicles relative to arrival at and departure from the plurality of ports at which freight is transferred between the plurality of zero emission vehicles and the plurality of fossil fuel burning vehicles.

27. The system of claim 25 further comprising:
a transaction agency in communication with the controller for debiting and crediting accounts of the owners/operators of plurality of zero emission and fossil fuel burning vehicles as their vehicles deliver freight to and pick up freight from the plurality of ports.

28. The system of claim 27 further comprising:
a fee collection agency for collecting fees from owners/operators of the plurality of fossil fuel burning vehicles to fund the ports.

29. The system of claim 25 wherein the plurality of ports are disposed about the perimeter of corresponding urban areas.
